(19) United States
(12) Patent Application Publication
(10) Pub. No.: US 2025/0299146 A1
(43) Pub. Date: Sep. 25, 2025

(54) METHOD FOR COMPARING TASK COMPLETION EFFICIENCY BETWEEN WORKER TYPES

(71) Applicant: Milan Madhavji, Mississauga (CA)

(72) Inventor: Milan Madhavji, Mississauga (CA)

(21) Appl. No.: 19/086,447

(22) Filed: Mar. 21, 2025

Related U.S. Application Data
(60) Provisional application No. 63/568,725, filed on Mar. 22, 2024.

(30) Foreign Application Priority Data
Mar. 18, 2025 (CA) 3268034

(51) Int. Cl. G06Q 10/0639; G06F 9/451

(52) U.S. Cl. CPC G06Q 10/06398; G06F 9/451

(57) ABSTRACT

A computer-implemented method includes acquiring performance indicators associated with a first and second worker type for completing a task, wherein the performance indicators include task duration metrics, expense metrics and accuracy metrics, inputting the performance indicators to a computing module, determining a cost efficiency index, a task completion rate and an accuracy rating associated with each of the first and second worker type, determining a difference between each of the cost efficiency index, the task completion rate and the accuracy rating of the first and second worker type, for each of the cost efficiency index, the task completion rate and the accuracy rating, ranking each of the first and second worker type relative to one another based on the difference, and, for each of the cost efficiency index, the task completion rate and the accuracy rating, forwarding a result of the ranking to a dashboard.

The present invention relates to quantifying task completion efficiency for a heterogeneous worker pool. More specifically, the present invention relates to a system and method for comparing task completion efficiency of different worker types in an organization.

### BACKGROUND

In the current era of rapid technological advancement, organizations are increasingly focused on identifying the optimal worker for executing any given task in a workflow. Whether the worker is human, automated, outsourced, gig, or remote, determining the most suitable candidate for task execution is helpful to enhance productivity, reduce errors, and optimize operational expenses. This shift in focus demands a nuanced understanding of the comparative effectiveness of diverse worker pools across various tasks, emphasizing the need for precise measurement of task completion efficiency along a variety of dimensions.

Traditionally, the efficiency of task execution was assessed using qualitative measures or basic quantitative metrics such as “time saved” or “number of tasks completed.” However, these metrics fall short of providing a holistic view of the efficiency gains or potential challenges posed by employing different worker types. With the advent of advanced automation technologies, including those leveraging machine learning and artificial intelligence, the conversation has evolved from merely automating tasks to evaluating the efficiency and effectiveness of automation compared to human, outsourced, or remote workers.

This evolution underscores the need for a comprehensive framework that quantitatively assesses the efficiency of task completion across different worker categories. Such a framework should consider not only the speed and accuracy with which tasks are completed but also the costs associated with each worker type, the impact on workflow and process integration, and the potential for error reduction or introduction. Moreover, it should account for the interaction between human workers and automated systems, exploring how these interactions influence overall task efficiency.

However, existing methods for evaluating and comparing the efficiency of workers in a heterogenous worker pool often suffer from limitations, such as industry-specific applicability, lack of detail, or inadequate consideration of the dynamic interplay between humans and machines. Despite progress in understanding task completion efficiency, there remains a significant gap in developing a universal, quantitative framework that captures the multifaceted aspects of work performed by humans, machines, outsourced, and remote workers. Such a framework is crucial for informed management decisions regarding task allocation, automation investment, and workforce optimization, including considerations for labor redistribution and adjustments to workforce size based on efficiency metrics.

Capturing, tracking, and mining for insights based on performance indicators across multiple dimensions have proven to be either impractical or excessively time-consuming and challenging for individuals or groups to perform manually. The complexity and volume of data involved in evaluating task completion efficiency across diverse worker types and across multiple dimensions of analysis make it impossible or impractically prohibitive for humans to process and analyze effectively. This limitation hinders organizations from gaining comprehensive insights into worker performance, optimizing their workflows and measuring or predicting the true impact on workflow efficiency using one worker type versus another. Consequently, a computer-implemented solution is highly desirable, as such a solution can efficiently handle large datasets, perform complex analyses, and generate actionable insights with greater accuracy and speed than manual methods.

### BRIEF SUMMARY

The present invention relates to quantifying task completion efficiency for a heterogeneous worker pool. More specifically, the present invention relates to a system and method for comparing task completion efficiency of different worker types in an organization.

In one aspect, a computer-implemented method includes acquiring, via an observability module, a plurality of performance indicators associated with a first worker type and a second worker type different from the first worker type for completing a task, wherein the plurality of performance indicators include task duration metrics, expense metrics and accuracy metrics, inputting the acquired plurality of performance indicators to a computing module, determining, via the computing module, a cost efficiency index, a task completion rate and an accuracy rating associated with each of the first worker type and the second worker type for completing the task, determining, via the computing module, a difference between each of the cost efficiency index, the task completion rate and the accuracy rating of the first worker type and the second worker type for completing the task, for each of the cost efficiency index, the task completion rate and the accuracy rating, ranking, via the computing module, each of the first worker type and the second worker type relative to one another based on the difference, and, for each of the cost efficiency index, the task completion rate and the accuracy rating, forwarding a result of the ranking to a dashboard to display the result of the ranking via an output module in data exchange communication with the computing module.

The plurality of performance indicators for at least one of the first worker type and the second worker type for completing the task may be collected continually. Display of the result of the ranking may be concurrent with the ranking. Ranking of the first worker type and the second worker type may be displayed selectively based on difference between any one of the cost efficiency index, the task completion rate and the accuracy rating. Each of the first worker type and the second worker type may be selected from one of a human worker, an automated worker, a remote worker, and an outsourced worker. The performance indicators for each of the first worker type and the second worker type may be collected over a plurality of repetitions of completion of the task and each of the cost efficiency index, the task completion rate and the accuracy rating associated with each of the first worker type and the second worker type for completing the task is calculated using performance indicators from the plurality of repetitions of completion of the task. In one aspect, the plurality of performance indicators further includes frequency-related data points, the frequency-related data points representing a frequency of performing the task.

In one aspect, the method further includes the step of generating, via an output module in data exchange communication with a graphical user interface, at least one graphical representation of the cost efficiency index, the task completion rate and the accuracy rating of the first worker type and the second worker type for completing the task and difference therebetween.

In one aspect, calculating the difference in task completion rate between the first worker type and the second worker type includes determining a first task completion rate of the first worker type, determining a second task completion rate of the second worker type, and, calculating a difference between the first task completion rate and the second task completion rate.

In one aspect, calculating the difference in the accuracy rating between the first worker type and the second worker type includes recording a first accuracy rating for completing the task by the first worker type, recording a second accuracy rating for completing the task by the second worker type, and, calculating a difference between the first accuracy rating and the second accuracy rating.

In one aspect, the method further includes generating an infrastructure-as-code file, via an implementation engine, for implementing at least one change to a workflow associated with completion of the task based on the relative ranking of the first worker type and the second worker type. The infrastructure-as-code file may include at least one machine-readable definition file configured to define computer architecture required for implementing the at least one change.

In another aspect, a system includes an observability module configured to acquire a plurality of performance indicators associated with a first worker type and a second worker type different from the first worker type for completing a task. The plurality of performance indicators include task duration metrics, expense metrics and accuracy metrics. A computing module is configured to determine a cost efficiency index, a task completion rate and an accuracy rating associated with each of the first worker type and the second worker type for completing the task and to determine a difference between each of the cost efficiency index, the task completion rate and the accuracy rating of the first worker type and the second worker type for completing the task and for ranking each of the first worker type and the second worker type relative to one another based on the difference for each of the cost efficiency index, the task completion rate and the accuracy rating. An output module is in data exchange communication with the computing module and is configured to forward a result of the ranking to a dashboard to display the result of the ranking for each of the cost efficiency index, the task completion rate and the accuracy rating.

The observability may be configured to acquire the plurality of performance indicators for at least one of the first worker type and the second worker type for completing the task continually. The output module may be configured to display the result of the ranking concurrently with the ranking. The output module may be configured to display relative ranking of the first worker type and the second worker type selectively based on difference between any one of the cost efficiency index, the task completion rate and the accuracy rating. Each of the first worker type and the second worker type is selected from one of a human worker, an automated worker, a remote worker, and an outsourced worker.

In one aspect, the system further includes a graphical user interface in data exchange communication with the output module configured to generate at least one graphical representation of the cost efficiency index, the task completion rate and the accuracy rating of the first worker type and the second worker type for completing the task and difference therebetween.

In another aspect, the system further includes an implementation engine configured to generate an infrastructure-as-code file for implementing at least one change to a workflow associated with completion of the task based on the relative ranking of the first worker type and the second worker type. The infrastructure-as-code file may include at least one machine-readable definition file configured to define computer architecture required for implementing the at least one change.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system for comparing task completion efficiency of different worker types, according to one aspect;

FIG. 2 illustrates a flow chart of a method for comparing task completion efficiency of different worker types, according to one aspect;

FIG. 3 illustrates a block diagram of a system for comparing task completion efficiency of different worker types, according to one aspect;

FIG. 4 illustrates example outputs of metrics associated with task completion efficiency in accordance with one aspect;

FIG. 5 illustrates metrics associated with task completion rate in accordance with one aspect;

FIG. 6 illustrates metrics associated with cost efficiency index in accordance with one aspect;

FIG. 7 illustrates metrics associated with accuracy rating in accordance with one aspect; and,

FIG. 8 illustrates worker types ranked by the system, in accordance with one aspect.

### DETAILED DESCRIPTION

The present invention relates to quantifying task completion efficiency for a heterogeneous worker pool. More specifically, the present invention relates to a system and method for comparing task completion efficiency of different worker types in an organization.

In most organizations, tasks are executed through a diverse workforce that includes a plurality of worker types including human employees, automated systems, outsourced partners, and remote contributors. This multifaceted approach to task completion necessitates a nuanced understanding of efficiency across different types of workers. By quantifying and comparing the efficiency of task completion by various actors-human workers, automated workers, outsourced workers, and remote workers-organizations can gain a comprehensive view of the operational dynamics involved.

Performance indicators, or efficiency metrics, for task completion by each type of worker involve several parameters, including the time each takes to complete a full task or portions of a task, the cost associated with contributions of each worker type, and the quality of work produced by each worker type. Furthermore, the adaptability and scalability of different worker types in response to task frequency and complexity provide valuable insights. For human workers, efficiency metrics might encompass internal staff costs, including salaries and benefits, alongside productivity measures and quality outcomes. For automated systems, efficiency considerations include computing costs, maintenance expenses, expenses associated with updates and troubleshooting, development outlays, and data storage fees, with a focus on automation's scalability and reliability. Outsourced and remote workers introduce variables such as geographical distribution management costs, communication efficacy, and the integration of diverse work cultures into the overall task completion process.

The quantification of these performance indicators allows organizations to determine the optimal mix of human, automated, outsourced, and remote contributions for specific tasks, considering factors such as total time to completion, overall costs, and quality benchmarks. This approach enables a strategic evaluation of task distribution, identifying opportunities for enhancing efficiency through the reallocation of resources or the reconfiguration of task execution strategies.

Measurement of performance indicators taking the above into account facilitates informed decisions on whether tasks can or should be automated, kept in-house, outsourced, or assigned to remote workers based on a holistic view of efficiency and effectiveness. By examining these diverse parameters, organizations can strategically navigate the complexities of modern work environments, optimizing task completion processes to achieve better outcomes, cost savings, and enhanced operational agility.

Additionally, recognizing that task completion can exist on a spectrum between fully human-driven to completely automated, allows for the proportion of automation and human effort to be determined. By measuring the contribution from each entity—whether automated or human—an organization can assess whether a task can be fully automated and the cost associated with automating the task to an adequate degree. Quantifying this offers organizations valuable perspectives on deciding if a task should be automated or is a human touch preferable.

Organizations can consider different parameters for quantifying task completion efficiency for different worker types or for deciding if a task should be automated. These parameters may include task duration metrics, expense metrics and accuracy metrics. The task duration metrics facilitate assessment of task completion efficiency along the dimension of time and facilitate determination of insights based on the time-related efficiency of completing a task using a particular worker type versus another. The expense metrics facilitate assessment of task completion efficiency along the dimension of cost and facilitate determination of insights based on cost savings associated with completing a task using a particular worker type versus another. The accuracy metrics facilitate assessment of task completion efficiency along the dimension of task completion accuracy and facilitate determination of insights based on “pass” and “fail” rates of task completion outputs using a particular worker type versus another. Performance indicators may also include task performance frequency, which relates to the regularity with which a task is performed. For instance, a frequently performed task, even if simple, may justify automation based on volume alone. By understanding the four parameters of cost, frequency, quality and speed of task completion, organizations can make more informed decisions about where to invest in automation and how to measure its success.

A computer-implemented method for comparing task completion efficiency between worker types offers significant advantages by efficiently and consistently capturing, tracking, and analyzing performance indicators for completing tasks across multiple dimensions and for diverse worker types. A computer-implemented solution is capable of efficiently handling large datasets and performing complex analyses with precision. This facilitates determination of comprehensive insights on task completion efficiency for various worker types and across multiple dimensions. Such an approach not only overcomes the limitation of humans being incapable or prohibitively inefficient in performing such granular calculations on such a large data set and determining such insights therefrom but also saves time and enables organizations to make informed decisions regarding task allocation and workforce optimization, ultimately enhancing productivity and reducing errors.

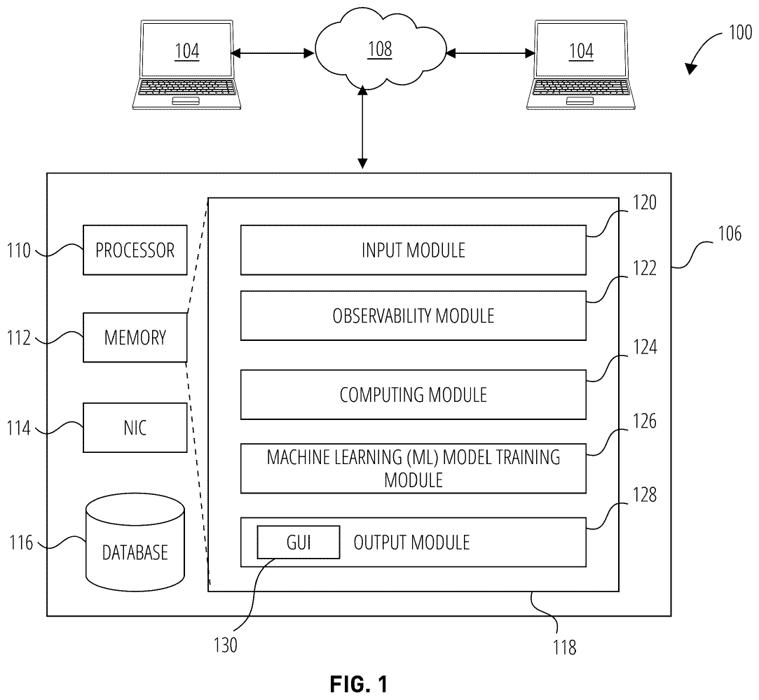

FIG. 1 illustrates a network implementation of an architecture including a system 100 for quantifying the task completion efficiency of different worker types in an organization.

“Organization” refers to a structured group of workers who collaborate to achieve common goals. This includes distribution of tasks or duties to workers or teams of workers and fulfillment of those tasks or duties for the functioning and success of the organization. In one aspect, the organization may be a “hybrid organization” which includes, among others, human workers, automated workers, gig workers, remote workers, and/or outsourced workers. It should be understood that the term “organization” may encompass other entity types.

“Workflow” refers to a defined sequence of tasks, steps, or processes that are executed to achieve a specific goal or result within an organization or system. Workflows are designed to systematically guide the completion of work, ensuring that it follows a structured and efficient path.

“Task” refers to a discrete unit of work or a specific activity to be performed by a worker. A single task may be a standalone work item or may be defined and organized within a workflow to accomplish a component of a more complex process or project. By breaking down complex processes or projects into smaller, manageable tasks, workflow can be distributed among workers for more efficient use of resources and streamlined progress towards an overall goal.

“Human worker” refers to a human individual who is directly employed by an organization to perform tasks, projects, or services as part of their employment within the organization. Human workers typically operate within the organizational framework and are subject to the policies, regulations, and benefits associated with formal employment. This term underscores the distinction between human workers, who are formal employees of the organization, and other categories of workers such as remote workers, outsourced workers, or gig workers, who may be engaged through different arrangements human work.

“Automated worker” refers to the use of technology, such as computer software, machines, robots, artificial intelligence systems or other systems, to perform tasks or portions of tasks automatically. Automation reduces or eliminates the need for human intervention when performing tasks. The advantages of automation include improvements in efficiency, reduction of errors, time savings, improvements in scalability and cost reduction. Examples of automated workers may include robotic assembly lines, automated software processes, or AI-powered systems performing specific functions within an organization.

“Remote worker” refers to an individual who conducts work activities outside of a traditional office environment, typically from a remote location such as a home office, co-working space, or any location separate from the central workplace. The term encompasses individuals who perform tasks, contribute to projects, or carry out responsibilities using digital technologies, communication tools, and internet connectivity to collaborate with colleagues and access company resources, all while operating remotely.

“Outsourced worker” refers to an individual or a team external to the organization who is engaged by the organization to perform specific tasks, projects, or services on behalf of the organization. These workers are not direct employees of the organization but are engaged through outsourcing arrangements, which may involve third-party service providers or independent contractors. The tasks or services outsourced to these workers may range from specialized projects to routine operational functions, and they are typically carried out off-site, often at the location of the service provider or contractor.

“Gig worker” refers to an individual who performs temporary, flexible, or freelance work on a project or task basis, often through digital platforms or app-based services. These workers are typically independent contractors who engage in short-term assignments or “gigs,” providing services or completing tasks based on demand and market opportunities. The nature of their work is often characterized by its transitory and non-traditional structure, with gig workers having the flexibility to take on multiple assignments from different sources, work remotely, and manage their own schedules.

As shown in FIG. 1, system 100 includes one or more user devices 104, which may comprise one or more computers. In various aspects, the one or more user devices 104 comprise multiple computers, which may comprise multiple, redundant, or replicated client computers accessible by one or more users. User device 104 may be any suitable device (e.g., a laptop, a smart phone, a tablet, a wearable device, a blade server, etc.). User device 104 may include a memory and a processor for, respectively, storing and executing one or more modules. The memory may include one or more suitable storage media such as a magnetic storage device, a solid-state drive, random access memory (RAM), etc.

The example aspect of FIG. 1 further includes one or more servers 106. Server 106 may include a single, standalone server or may include a plurality of servers in data exchange communication with one another, such as in a server system environment.

As described herein, in some aspects, server 106 may perform the functionalities as discussed herein as part of a “cloud” network or may otherwise communicate with other hardware or software components within one or more cloud computing environments to send, retrieve, or otherwise analyze data or information described herein. For example, in aspects of the present techniques, the cloud computing environment may comprise a customer on-premise computing environment, a multi-cloud computing environment, a public cloud computing environment, a private cloud computing environment, and/or a hybrid cloud computing environment. For example, the customer may host one or more services in a public cloud computing environment (e.g., Alibaba Cloud™, Amazon Web Services (AWS), Google Cloud™, IBM Cloud™, Microsoft Azure, etc.). The public cloud computing environment may be a traditional off-premise cloud (i.e., not physically hosted at a location owned/controlled by the customer). Alternatively, or in addition, aspects of the public cloud may be hosted on-premise at a location owned/controlled by the customer. The public cloud may be partitioned using visualization and multi-tenancy techniques, and may include one or more of the customer's IaaS and/or PaaS services.

User device 104 and server 106 are connected by way of network 108. The network 108 may comprise any suitable network or networks, including a local area network (LAN), wide area network (WAN), Internet, or combination thereof. For example, the network 108 may include a wireless cellular service (e.g., 4G). Generally, the network 108 enables bidirectional communication between the user device 104 and the server 106. In some aspects, network 108 may comprise a cellular base station, such as cell tower(s), communicating to the one or more components of the architecture 102 via wired/wireless communications based on any one or more of various mobile phone standards, including NMT, GSM, CDMA, UMMTS, LTE, 5G, or the like. Additionally or alternatively, network 108 may comprise one or more routers, wireless switches, or other such wireless connection points communicating to the components of the system 100 via wireless communications based on any one or more of various wireless standards, including by non-limiting example, IEEE 702.11a/b/c/g (WIFI), the BLUETOOTH standard, or the like.

The server 106 may include a processor 110, memory 112, a network interface controller (NIC) 114 and an electronic database 116. The NIC 114 may include any suitable network interface controller(s), and may communicate over the network 108 via any suitable wired and/or wireless connection. The server 106 may include one or more input device (not depicted) and may include one or more device for allowing a user to enter inputs (e.g., data) into the server 106. For example, the input device may include a keyboard, a mouse, a microphone, a camera, etc. The NIC 114 may include one or more transceivers (e.g., WWAN, WLAN, and/or WPAN transceivers) functioning in accordance with IEEE standards, 3GPP standards, or other standards, and that may be used in receipt and transmission of data via external/network ports connected to network 108.

In the aspect of FIG. 1, there is also connected to server 106, via network 108, database 116 which may be used to access or upon which may be stored data required for operation of the system 100 as described herein. The database 116 may be a relational database, such as Oracle, DB2, MySQL, a NoSQL based database, such as MongoDB, or another suitable database. The database 116 may store data used to train and/or operate one or more machine learning (ML)/artificial intelligence (AI) models. The database 116 may store runtime data (e.g., a customer response received via the network 108). In various aspects, server 106 may be referred to herein as “migration server(s).” The server 106 may implement client-server platform technology that may interact, via the computer bus, with the memory 112 (including the applications(s), component(s), API(s), data, etc. stored therein) and/or database 116 to implement or perform the machine readable instructions, methods, processes, elements or limitations, as illustrated, depicted, or described for the various flowcharts, illustrations, diagrams, figures, and/or other disclosure herein.

In some aspects, the database 116 stores historical information which may include historical data relating to completion of tasks in an organization by different worker pools. The database may also store, among others, performance indicators such as task duration metrics, expense metrics and accuracy metrics. In one aspect, the task duration metrics, expense metrics and accuracy metrics, respectively, are cost-related data points, time-related data points, quality-related data points, and frequency-related data points, related to a plurality of tasks in a workflow. In one aspect, the performance indicators for each of the first worker type and the second worker type are collected over a plurality of repetitions of completion of a task.

The expense metrics may include, among others, implementation costs, computing costs, development cost, human resource costs, maintenance costs, and data storage costs associated with a task completed by various worker types. Implementation costs refer to upfront expenses incurred, for example when implementing an automation solution. This would include costs for hardware, software, licensing, and any required infrastructure changes. Computing costs refer to expenses related to computational power, servers, and other hardware components. Development costs refer to cost associated with creating, training, and fine-tuning the automated process. Human resource costs may include internal staff costs, outsourcing costs, costs related to managing geographically distributed teams, and cost related to employing or contracting engineers to maintain the systems. Maintenance costs include ongoing costs related to the upkeep and support of the systems. This includes expenses for software updates, hardware maintenance, and technical support. Data storage costs refer to expenses related to store, backup, and secure the large datasets that automation often requires. Database 116 may include one or more organized data sources accessible by server 106, processor 110 and/or various modules described herein to serve as inputs for a set of computer-readable instructions, as inputs for a machine learning model or as training data for training a machine learning model for quantifying completion efficiency of tasks by different worker types in the organization. Such a data source may be a collection of data of any size or a plurality of data collections such as on a spreadsheet or some other suitable format readable by a computer.

The task duration metrics refer to variables that pertain to the timing, scheduling, or duration of a task for completion. The task duration metrics may be used to determine how quickly and efficiently tasks can be completed by different worker pools. In one aspect, the task duration metrics may include, among others, the amount of time it takes for a human worker to complete a task, the amount of time it takes for an automated worker to complete a task, time it takes for a remote worker to complete a task, the time saved by automation of a task, timeout parameters that define the maximum amount of time allowed for a task to complete, lead time required to prepare or set up a task, cool-down period after completion of a task, and synchronization points for ensuring certain tasks in a workflow are completed before others begin to maintain the correct sequence and consistency.

The accuracy metrics may be used to measure the quality and consistency of outputs of tasks completed by different types of workers. This may be valuable information, for instance, in comparing output of a human worker to that of an automated worker. In such a case, an error rate may be used to quantify the frequency and severity of errors or defects in outputs of tasks before and after automation. Lower error rates indicate improved accuracy. Accuracy metrics may include, for example, success rate of task completion for different worker types including, human worker, automated worker, remote worker, and outsourced worker. In one aspect, success rate may be measured as a pass or fail percentage.

The frequency-related data points refer to metrics and considerations associated with how often specific tasks are performed. These data points may be used to assess the impact of completing the task by different worker types on task frequency, scheduling, and overall operational efficiency. Measuring the frequency of performing tasks is also useful for analyzing which tasks may be prioritized for automation. Tasks performed frequently may make stronger targets for automation due to expected return on volume.

Server 106 may include a processor 110, memory 102, a network interface controller (NIC) 112. The processor 110 may include one or more suitable processors (e.g., central processing units (CPUs) and/or graphics processing units (GPUs)). The processor 110 may be connected to the memory 112 via a computer bus (not depicted) responsible for transmitting electronic data, data packets, or otherwise electronic signals to and from the processor 110 and memory 112 in order to implement or perform the machine readable instructions, methods, processes, or elements, as illustrated, or described herein. The processor 110 may interface with the memory 112 via a computer bus to execute an operating system (OS) and/or computing instructions contained therein, and/or to access other services/aspects. For example, the processor 110 may interface with the memory 112 via the computer bus to create, read, update, delete, or otherwise access or interact with the data stored in memory 112 and/or the database 116.

The memory 112 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 112 may store an operating system (OS) (e.g., Microsoft Windows™, Linux™, UNIX™, etc.) capable of facilitating the functionalities, apps, methods, or other software as discussed herein.

The memory 112 may store a management platform 118, having as components thereof one or more modules each configured to implement respective sets of computer-executable instructions as described herein. In general, a computer program or computer based product, application, or code (e.g., the model(s), such as machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 110 (e.g., working in connection with the respective operating system in memory 112) to facilitate, implement, or perform the machine readable instructions, methods, processes, or elements, as illustrated, or described herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

In some aspects, the management platform 118 may include an input module 120, comprising a set of computer-executable instructions implementing communication functions. The input module 120 may include a communication component (not shown) configured to communicate (e.g., send and receive) data via one or more external/network port(s) to one or more networks or local terminals, such as network 108 and/or the user device 104 (for rendering or visualizing) described herein. In some aspects, server 106 may include a client-server platform technology such as ASP .NET, Java J2EE, Ruby on Rails, Node.js, a web service or online API, responsive for receiving and responding to electronic requests.

Input module 120 may further include or implement an operator interface configured to present information to an administrator or operator and/or receive inputs from the administrator and/or operator. Input module 120 may facilitate I/O components (e.g., ports, capacitive or resistive touch sensitive input panels, keys, buttons, lights, LEDs), which may be directly accessible via, or attached to, server 106 or may be indirectly accessible via or attached to the user device 104.

In some aspects, the management platform 118 may include an observability module 122 for collecting, aggregating, and analyzing the data inputted into the system via input module 120. In some aspects, the observability module 122 collects various types of data from the input module 120 and/or the database 116. This collected data includes a plurality of performance indicators or data points associated with different worker types for completing tasks in a workflow. For instance, performance indicators may include task duration metrics, expense metrics and accuracy metrics, and particularly the data points include cost-related data points, time-related data points, quality-related data points, and frequency-related data points for each of a human worker, an automated worker, a remote worker, and an outsourced worker for completing any given task in the organization. Performance indicators may be collected continually as instances of a task are performed. The observability module 122 can help provide holistic visibility into the system, thereby enabling proactive detection and resolution of any unexpected issues. The observability module 122 is also designed to provide real-time monitoring capabilities and triggers alerts based on predefined criteria.

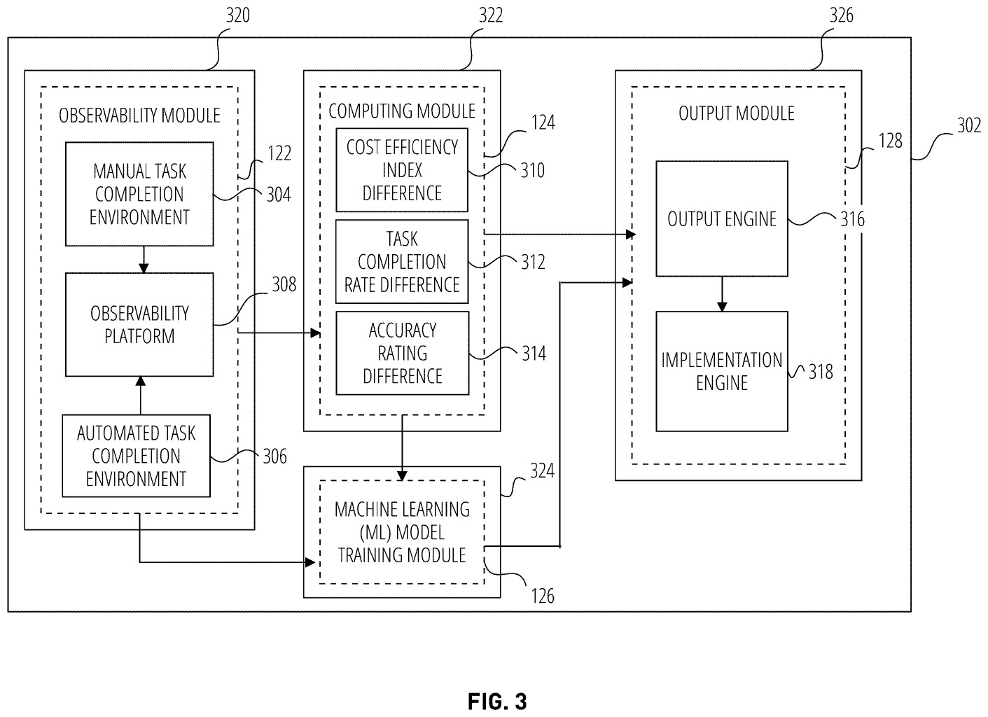

In some aspects, observability module 122 may include or be in data exchange communication with an observability platform 308 (FIG. 3) which offers deeper insights into the data obtained from the input module 120, observability module 122 and database 116, enabling faster issue detection and resolution. One component of the observability platform includes performance metrics including quantitative data like response times and resource usage, logs including records of events that have occurred within the system, and traces which track individual requests or tasks as they move through the system or workflow, and so on. The observability platform may allow for tracking of how tasks in a workflow are completed by different worker types. In some aspects, the observability platform may use artificial intelligence (AI) to monitor and provide insights and recommendations for performance optimization for the completion of tasks by different worker types.

In some aspects, the management platform 118 may include a computing module 124, comprising a set of computer-executable instructions implementing computation or calculation of at least one of a cost efficiency index, a task completion rate and an accuracy rating associated with completion of task by different worker types. The computing module 124 may be integrated with a knowledge engine to allow for retrieval and processing of information related to the tasks, data analysis, and other forms of artificial intelligence-driven analysis. The knowledge engines may be connected with the other modules including input module 120, observability module 122, and database 116 for a seamless flow of information related to the tasks. In the aspect wherein the performance indicators for each of the first worker type and the second worker type are collected over a plurality of repetitions of completion of the task, each of the cost efficiency index, the task completion rate and the accuracy rating associated with each of the first worker type and the second worker type for completing the task is preferably calculated using performance indicators from the plurality of repetitions of completion of the task.

In one aspect, the management platform 118 may include a machine learning (ML) model training module 126, comprising a set of computer-executable instructions implementing machine learning training, configuration, parameterization and/or storage functionality. The ML model training module 126 may initialize, train and/or store one or more ML knowledge engines, as discussed herein. The ML knowledge engines, or “engines” may be stored in the database 116, which is accessible or otherwise communicatively coupled to the server 106. The management platform 118 may store machine readable instructions, including one or more application(s), one or more software component(s), and/or one or more application programming interfaces (APIs), which may be implemented to facilitate or perform the features, functions, or other disclosure described herein. For example, at least some of the applications, software components, or APIs may be, include, otherwise be part of, an environmental discovery, validation and automatic knowledge generation machine learning model or system.

Machine learning may involve identifying and recognizing patterns in existing data (such as data risk issues, data quality issues, sensitive data, etc.) in order to facilitate making predictions, classifications, and/or identifications for subsequent data (such as using the models to determine or generate a classification or prediction for, or associated with, applying a data governance engine to train a descriptive analytics model).

Machine learning model(s), may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

Supervised learning and/or unsupervised machine learning may also comprise retraining, relearning, or otherwise updating models with new, or different, information, which may include information received, ingested, generated, or otherwise used over time. The disclosures herein may use one or both of such supervised or unsupervised machine learning techniques.

In some aspects, the ML model training module 126 may train a machine learning based model for identifying tasks suitable for automation. The dataset for training this model may involve collecting and annotating various tasks, both automated and manual, indicating which tasks are currently automated and which are not. Thereafter, feature extraction may be carried out by identifying key characteristics of the tasks including repetitiveness, complexity, time consumption, and error rate. The ML model training module 126 can then train the machine learning based model on this dataset to discern patterns and correlations that distinguish automatable tasks from non-automatable ones. Through iterative training and validation, the model learns to predict the automation potential of a task with increasing accuracy. This predictive capability can then be applied in real-world scenarios to assist decision-makers in identifying tasks within an organization that are good candidates for automation, thereby enhancing efficiency and productivity.

In some aspects, the ML model training module 126 may train a machine learning model for testing and validating the automation of tasks based on the performance indicators for an automated worker and historical information stored in the database 116. The performance indicators help define the difference between the outcome of completing a task with a human worker versus an automated worker. Historical information may include errors detected in previous iterations of automating a task. The ML model training module 126 can flag a task as a good candidate for model training and collect the data on the difference between the automated result and manual result into a training queue. Once the threshold for training data is met, a new machine learning model can be trained, tested and implemented to bring the automated output of a task to achieve or surpass the manual output of the task. The ML model training module 126 allows for bringing the automated capabilities closer toward the desired output.

In some aspects, the ML model training module 126 may train a machine learning based model for comparing and validating different automation processes for task automation. The dataset for training this model may involve collecting and annotating a variety of automated tasks along with their outcomes, performance metrics, and any relevant parameters. This dataset might include information on task completion times, error rates, resource utilization, and user feedback. The machine learning based module is then trained with this data to identify patterns and indicators of successful automation including task complexity, frequency of errors, or user satisfaction levels. As the model processes this data, it learns to assess the efficiency and effectiveness of automated tasks. Once trained, this ML module can be used to continually monitor and test automated tasks, providing insights into areas for improvement, potential failures, or opportunities for further automation. This may enhance the overall quality and reliability of automated systems so as to meet desired standards and adapt to evolving requirements.

In some aspects, the management platform 118 includes an output module 128, which serves various functions within the disclosed system. In some aspects, the output module 128 is configured to incorporate a graphical user interface (GUI) 130 as a component. The GUI 130, as a constituent part of the output module 128, facilitates user interaction and visualization capabilities within the system. Alternatively, it is also contemplated that the GUI 130 may be established as an independent module, distinct from the output module 128. Irrespective of the structural arrangement, the output module 128 and GUI 130 collectively generate a graphical representation of the cost score, speed score, and quality score associated with a worker type for completing a task, thus providing a comprehensive and user-friendly presentation of the relevant data points. The graphical representation of the cost score, speed score, and quality score allows for an easier determination of an optimal worker type for a task. In one aspect, the scores associated with a worker type may be color coded to highlight potential problem areas. For instance, if a score associated with a worker type is optimal, it can be represented in green while an unacceptable score is shown in red.

In one aspect, output module 128 is in data exchange communication with the computing module 124 for forwarding a result of the ranking to a dashboard to display the result of the comparison for each of the cost efficiency index, the task completion rate and the accuracy rating. In some aspects, the GUI 130 can include interactive features, such as allowing users to customize and filter the displayed data based on specific parameters, providing a dynamic and tailored visualization experience. Additionally, the GUI 130 may incorporate visual analytics tools, enabling users to conduct in-depth exploratory data analysis, identify trends, and gain insights into the performance metrics and worker type scores. The GUI 130 can also support real-time updating of data and scores, ensuring that users have access to the most current information for decision-making. Furthermore, it can provide customizable dashboards and reporting capabilities, empowering users to create personalized views and reports tailored to their individual needs.

In general, the word “module,” as used herein, refers to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware devices (such as processors and CPUs) may be comprised of connected logic units, such as gates and flip-flops, and/or may be comprised of programmable units, such as programmable gate arrays or processors. The modules or computing device functionality described herein are preferably implemented as software modules but may be represented in hardware devices. Generally, the modules described herein refer to software modules that may be combined with other modules or divided into sub-modules despite their physical organization or storage.

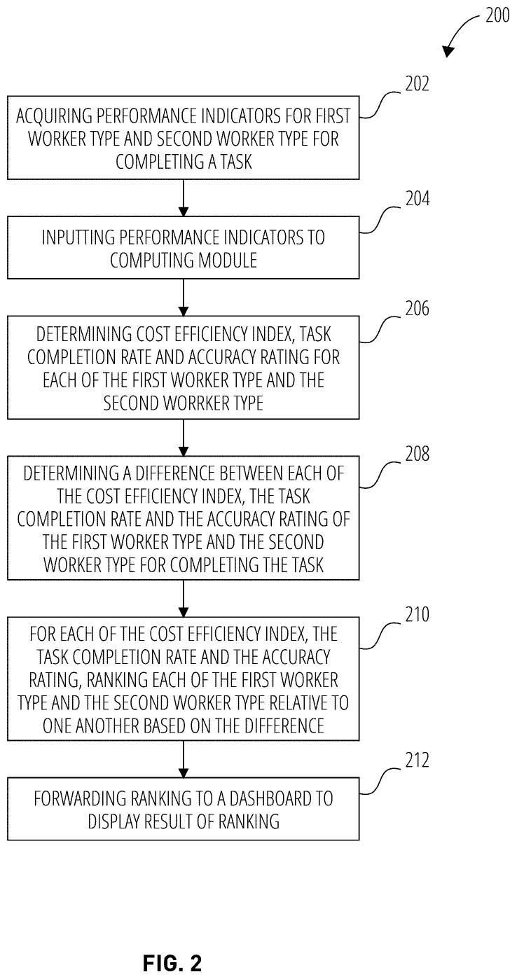

FIG. 2 is a flow chart illustrating a method 200. In one aspect, method 200 facilitates comparison, including quantification and measurement, of task completion efficiency between worker types. The workflow in an organization may be divided into a plurality of tasks based on predefined goals and criteria to allow for better organization, delegation, and tracking of progress of the workflow. The method 200 may be implemented in any suitable hardware, software, firmware, or combination thereof. In one aspect, the method 200 may be implemented on the system 100 of FIG. 1. The method 200 may be described in the general context of computer executable instructions.

The method 200 begins at block 202 for acquiring a plurality of performance indicators associated with a first worker type and a second worker type different from the first worker type for completing a task. In one aspect, time-related data points, cost-related data points, quality-related data points, and frequency-related data points are measured and input to the input module 120 or are stored in database 116. The performance indicators are then acquired by the observability module 122 from the input module 120 and/or the database 116. The performance indicators are associated with different worker types, including, among other, a human worker, an automated worker, automated workers from different generations of development, a remote worker, or an outsourced worker, for completing a given task in the workflow. The plurality of performance indicators include task duration metrics, expense metrics and accuracy metrics and in some aspects may more specifically include, among others, time-related data points, cost-related data points, quality-related data points, and frequency-related data points associated with task performance by the first worker type and the second worker type.

At block 204, the plurality of performance indicators acquired by the observability module 122 are input to a computing module 124. In a next step shown at block 206, the method 200 includes determining a cost efficiency index, a task completion rate and an accuracy rating associated with each of the first worker type and the second worker type for completing the task. In one aspect, this determination is achieved by way of one or more calculations performed by the computing module 124.

At block 208, the method 200 includes determining, via the computing module 124, a difference between each of the cost efficiency index, the task completion rate and the accuracy rating of the first worker type and the second worker type for completing the task. The difference in cost efficiency index provides insights into the financial implications of assigning a given task to a one worker type over another. The difference in task completion rate quantifies the efficiency gains or losses achieved by using one worker type over another worker type. The difference in accuracy rating provides a measure of the reliability and effectiveness of one worker type in successfully executing tasks as compared to another worker type.

In a next step shown at block 210, the method 200 includes, for each of the cost efficiency index, the task completion rate and the accuracy rating, ranking each of the first worker type and the second worker type relative to one another based on the difference. The ranking is conducted via the computing module 124.

In some aspects, a greater difference may correspond to a higher ranking. Preferably, a greater difference in one worker type over another implies greater cost savings, less time spent on completing tasks or increases in quality by using the worker type that produces the greater difference. In some aspects, a smaller difference produced by one worker over another may be preferable and may result in a higher ranking.

Method 200 may include the further step shown at block 212 of forwarding, for each of the cost efficiency index, the task completion rate and the accuracy rating, a result of the ranking to a dashboard to display the result of the ranking. This may be performed by an output module 128 in data exchange communication with the computing module 124. The graphical representation offers a user-friendly visualization that enables stakeholders to visualize and comprehend the key performance indicators related to task completion by the first worker type and the second worker type. The cost efficiency index quantifies the expenses attributed to the worker's activities, the task completion rate reflects the efficiency of task completion in terms of time, and the accuracy rating serves to assess the accuracy and standard of the completed work. The integration of these scores into a graphical format fosters a holistic understanding of the second worker type's performance across these critical dimensions.

By presenting this information graphically, the system provides users with an intuitive means to interpret and compare the relative strengths and weaknesses of the second worker type's task completion attributes against those of the first worker type. This graphical representation serves as a valuable tool for decision-making, facilitating the identification of optimal worker types for specific tasks based on various performance criteria. In one aspect, a user may make a decision on choosing the optimal worker for the task based on one or more of the cost score, speed score, and the quality score associated with a specific worker type completing the task. The optimal worker may be chosen from between the first worker type and the second worker type based on the parameter or score being optimized.

Although improvement in workflow processes can be achieved using human workers, decision-makers must often decide whether a next step in improvement of workflow is best facilitated by an automated worker type. FIG. 3 illustrates a block diagram of a computer-implemented method 302. In one aspect, computer-implemented method 302 facilitates comparison of a difference in performance indicators between human worker types and automated worker types, in accordance with one aspect of the present disclosure.

In block 320, metrics and parameters for a human worker completing a given task are provided to a manual task completion environment 304 in the observability module 122. A “manual task completion environment 304” refers to a data-based representation of a setting or system wherein tasks are completed by human effort without the assistance of automated workflow processes or artificial intelligence tools. This environment is characterized by performance indicators related to task completion wherein at least one human worker type is responsible for the decision-making and physical or intellectual execution of tasks. Data from this environment is used as a baseline or control to measure difference in performance indicators associated with task completion by automated worker types.

The computer-implemented method 302 further includes providing metrics and parameters for an automated worker completing the same task as in the manual task completion environment 304, but in this case, to an automated task completion environment 306. An “automated task completion environment 306” refers to a data-based representation of a setting or system in which tasks are performed by or with the assistance of automated worker types, such as machines having programmed algorithms, software applications, robotics, or other technologies designed to operate with minimal to no human intervention. This environment is characterized by performance indicators related to task completion wherein automated worker types, such as machines and computational processes are used to complete tasks, often leading to increased consistency, speed, and accuracy. The data from this environment is analyzed to measure the impact of automation on various aspects of task completion and work flow, particularly with respect to cost, time, and quality.

In some aspects, the performance indicators for a human worker completing a task and an automated worker completing a task may be obtained using the input module 120 of FIG. 1. In another aspect, some of the performance indicators may be stored in the database 116 of FIG. 1. The plurality of performance indicators include task duration metrics, expense metrics and accuracy metrics and in some aspects may more specifically include, among others, time-related data points, cost-related data points, quality-related data points, and frequency-related data points. The task duration metrics include at least one of time taken by the human worker to complete a task, time taken by the automated worker to complete the task, time saved by the automation of the task, maximum amount of time allowed for the task to complete, lead time required to prepare or set up a task, and cool-down period after completion of the task. The expense metrics include cost associated with the human worker completing the task and cost associated with the automated worker completing the task. The accuracy metrics include success rate and accuracy of completion of task with each of a human worker and an automated worker. The frequency-related data points include a frequency of performing the task, and wherein a higher frequency of completing the task indicates a higher prioritization for the automation of the task.

In one aspect, block 320 may be implemented via an observability platform 308 of the observability module 122 shown in FIG. 1. In this aspect, input module 120 provides performance indicators to the observability module 122 and particularly to the manual task completion environment 304 and automated task completion environment 306, respectively. In one aspect, the performance indicators are provided to observability module 122 in the form of time-related data points, cost-related data points, quality-related data points, and frequency-related data points. The observability platform 308 enables users to mine performance indicator data for analysis purposes. Analysis of performance indicator data facilitates user-generated insights into the data obtained from the manual task completion environment 304 and the automated task completion environment 306. One component of the observability platform 308 includes metrics which provide quantitative data points including CPU usage, response time, cost, speed calculations, and so on. Observability platform 308 also provides logs or unstructured data records capturing events and activities in the manual task completion environment 304 and the automated task completion environment 306. Observability platform 308 further allows for tracking how tasks in a workflow are completed. In some aspects, observability platform 308 may use artificial intelligence (AI) to monitor and provide insights and recommendations for performance optimization for the manual task completion environment 304 and automated task completion environment 306.

The computer-implemented method 302 may further include, at block 322, computing a cost efficiency index difference 310, task completion rate difference 312, and an accuracy rating difference 314 associated with automating the task. The cost efficiency index difference 310, task completion rate difference 312, and the accuracy rating difference 314 are computed using the performance indicators from the manual task completion environment 304 and automated task completion environment 306 and, in some aspects, may also use various other metrics associated with completion of the task. The computation of the cost efficiency index difference 310, task completion rate difference 312, and the accuracy rating difference 314 can be carried out in the computing module 124 of FIG. 1. As discussed above with regard to FIG. 1, knowledge engines may be integrated into the computing module 124. In some aspects, the computer-implemented method 302 may utilize knowledge engines integrated into the computing module 124 for computation of each of a cost efficiency index difference 310, task completion rate difference 312, and an accuracy rating difference 314 associated with automating the task. Each of the differences is computed by calculating a difference between each of the cost efficiency index, the task completion rate and the accuracy rating associated with the automated worker type completing a task and the cost efficiency index, the task completion rate and the accuracy rating associated with the human worker type completing the same task. In one aspect, the data points associated with a human worker type completing the task are used as a benchmark for computing the difference in performance indicators associated with automating the task. The cost efficiency index difference 310 provides insights into the financial implications of automating a given task. The task completion rate difference 312 quantifies the efficiency gains achieved through automation and the accuracy rating difference 314 provides a measure of the reliability and effectiveness of automation in successfully executing tasks as compared to manual processes. The knowledge engines at block 322 leverage built-in knowledge powered from multiple data sources to facilitate the computation of the differences between performance indicators to facilitate decision-making toward automating the task or not automating the task. The knowledge data pipelines are beneficial for keeping knowledge up to date and aligned with the latest automation trends.

At block 324, the computer-implemented method 302 may further include training a machine learning model based on the performance indicators acquired from the observability module 122 and the cost efficiency index differences 310, task completion rate difference 312, and accuracy rating difference 314. The training and operation of the knowledge engines at block 322 and block 324 may be performed by using, for example, the ML model training module 126 of FIG. 1. The ML model training module 126 can flag a task as a good candidate for model training and collect the data on the performance indicators and differences therebetween among the results produced by the automated worker type and the human worker type and place that data into a training queue. Once the threshold for training data is met, a new machine learning model can be trained, tested and implemented to suggest changes which will alter the differences in performance indicators between automated worker types and human worker types in favor of the automated worker types. Therefore, the ML model training module 126 facilitates bringing the automated capabilities closer toward the desired output. The computer-implemented method 302 may use block 324 to periodically assess the automation of tasks and recommend alternate automation methods.

The output of the knowledge engines at block 322 and the machine learning models at block 324 may be received at the output engine 316 of the output module 128. For each of the cost efficiency index difference 310, task completion rate difference 312 and accuracy rating difference 314, the output engine 316 ranks each of the human worker type and the automated worker type relative to one another based on differences in performance indicators therebetween. The output engine 316 may also generate a report or graphical representation of the differences and ranks that is displayable to a user. In one aspect, a user may make a decision on choosing the optimal worker type based on one or more of the cost efficiency index difference 310, task completion rate difference 312, and the accuracy rating difference 314 associated with automating the task. The optimal worker may be chosen from one of human worker or automated worker based on the parameter being optimized. In another aspect, machine learning models may be used to choose an optimal worker based on one or more of the cost efficiency index difference 310, task completion rate difference 312, and the accuracy rating difference 314 associated with automating the task.

The computer-implemented method 302 may further include processing outputs of the output engine 316 using an implementation engine 318. Implementation engine 318 may be configured to implement automation of the task if the automated worker type is chosen as the optimal worker based on the differences and ranks among performance indicators associated with automating the task. In a further aspect, the implementation engine 318 may be used by the user to generate infrastructure-as-code, preferably as one or more infrastructure-as-code files, for implementing at least one change to computational architecture to improve completion of the task. “Infrastructure-as-Code” refers to the practice of managing and provisioning computing infrastructure through machine-readable definition files, rather than through physical hardware configuration or interactive configuration tools. This approach enables developers and information technology professionals to automate the setup, configuration, and management of infrastructure such as servers, databases, networks, and other computing resources.

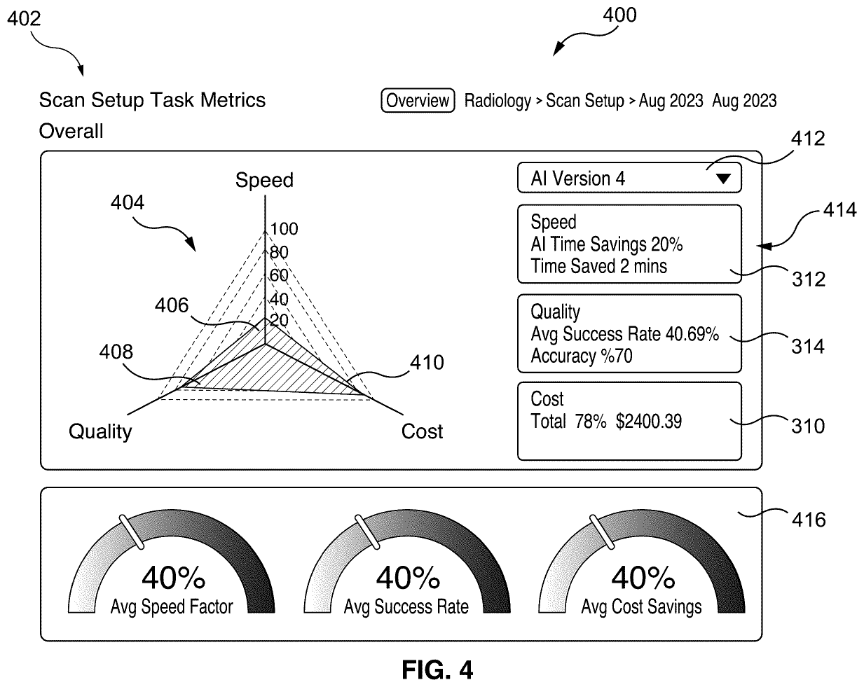

FIG. 4 to FIG. 8 are exemplary illustrations of visualizations available to a user accessing system 100. Such visualization capabilities may be provided by way of a dashboard accessible via observability platform 308, for example and facilitate decision-making in relation to assignment of specific worker types to certain tasks based on differences in performance indicators between worker types for completing specific tasks.

FIG. 4 is a graphical representation 400 of an exemplary output of method 200, according to one aspect. Such a graphical representation 400 may be provided by output engine 316, as previously discussed. The information shown in FIG. 4 provides numerical information and visualization which may be used by a decision-maker to determine whether a task should be performed by a first worker type or a second worker type. In the aspect, shown in FIG. 4, the second worker type is an automated worker in the form of an artificial intelligence (AI) application or system. The first worker type may be either a human (manual) worker type or an automated worker of a previous generation which may be of a different efficiency level than the second worker type.

Graphical representation 400 includes a task identification 402 which may be a task name or a number identifying the task. Graphical representation 400 further includes a visualization 404 of the task completion rate 406, accuracy rating 408 and cost efficiency index 410 of the second worker type. In one aspect, graphical representation 400 further includes a build identifier or generation identification number 412 which identifies the version of the second worker type which, in this aspect, is an automated worker. This is useful information in any aspect, but particularly when ranking differences in cost efficiency index, task completion rate and accuracy rating between one automated worker type and another automated worker type.

Graphical representation 400 further includes a table summarizing the task completion rate difference 312, accuracy rating difference 314 and cost efficiency index difference 310 provided by the second worker type versus the first worker type. These differences may be quantified as a percentage difference, in each case, or may be reflected as an empirical amount, such as in minutes, seconds or dollars, for example. In the aspect shown in FIG. 4, there is also provided a set of averages 416 which represent a running average of time, accuracy and cost savings provided by the second worker type versus the first worker type. Preferably, this is represented as a percentage, but may be represented by way of any suitable quantity, empirical or relative.

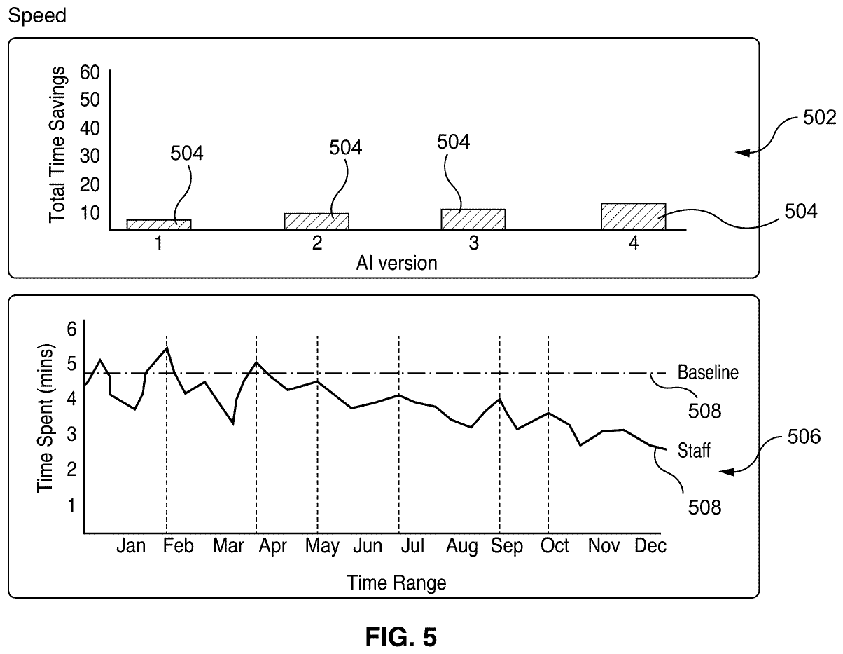

FIG. 5 illustrates the metrics associated with the task completion rate for completion of the task shown in FIG. 4. Once the difference between the cost efficiency index, task completion rate and accuracy rating between a first worker type and a second worker type are known, they may be represented graphically in any suitable manner to provide calculated total time savings to a user.

In a first graphical representation 502, the difference in task completion rate, represented by total time saved 504, provided by four automated worker types is shown. Each of the four automated worker types is an artificial intelligence or “AI” worker of a different version or generation. The first graphical representation 502 provides an easy-to-interpret reference to a user attempting to discern the advantages between different automated worker types.

Improvements in task completion rate may also be shown over time. Second graphical representation 506 shows a baseline or benchmark time 508 associated with a human worker for completing the task. Benchmark time 508 is established and is then used to compare against the time taken by an automated worker to complete the same task. The time saved 504 by an automated worker over time is shown by the distance or difference at any time value between the benchmark time 508 and the time spent 510 by the automated worker. The second graphical representation 506 may be updated to show time spent 510 for any of the automated workers having performance indicators in system 100. In particular, a user may select one of the automated workers represented in the first graphical representation 502 by selecting or “clicking” on one of the bars in the bar chart shown in 502 to refresh the second graphical representation 506 to show the data for the selected automated worker.

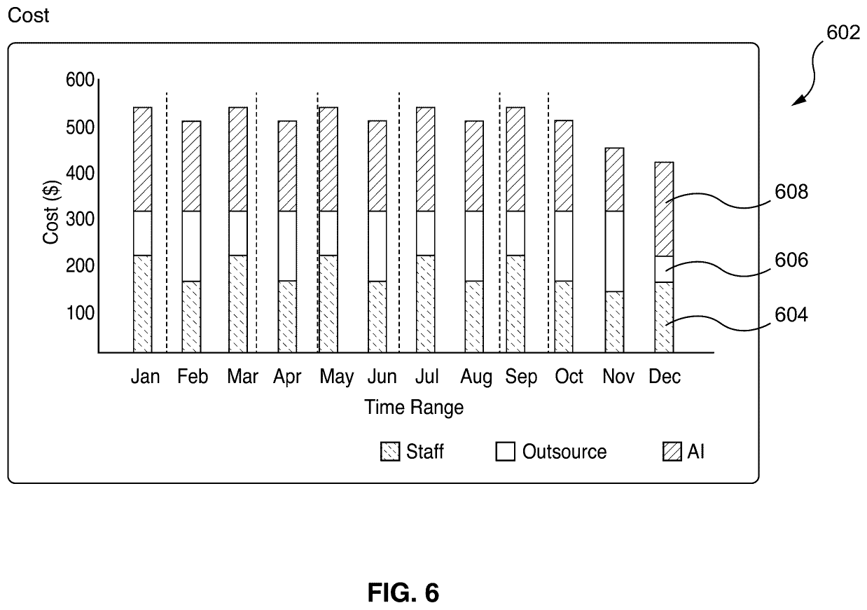

FIG. 6 illustrates the cost efficiency index associated with different worker types involved in completion of instances of the same task over time. In FIG. 6, the cost efficiency indices for human worker types including employees or staff, outsourced workers and automated or AI workers over a time range of 12 months are shown in graphical representation 602. As seen in FIG. 6, the cost efficiency index associated with completion of instances of a task over the time range is divided into cost efficiency index for internal staff cost 604 for employee or staff workers, outsourcing staff cost 606 for outsourced workers, and automation cost 608 for automated or AI workers. The internal staff cost 604 for a task may include, for example, salary of human workers associated with the task, equipment costs associated with the human worker and may factor in other forms of compensation such as benefits, salary bonuses. The outsourcing staff cost 606 for a task may include salary or contract costs of outsourcing staff associated with completion of the task. The automation cost 608 may include, among others, automation development costs, computing costs, data storage costs, maintenance engineer costs associated with the task. Preferably, each of these cost efficiency indexes is divided by the number instances of the task completed over the time range in order to provide an approximation of the expense metrics associated with completion of a single instance of the task. In another aspect, system 100 may be used to provide a global visualization of the cost efficiency indexes associated with completion of all tasks by different worker types over a time range, such as twelve months. Thereby, the cost efficiency indexes associated with each worker type for performance of instances of all tasks may be estimated.

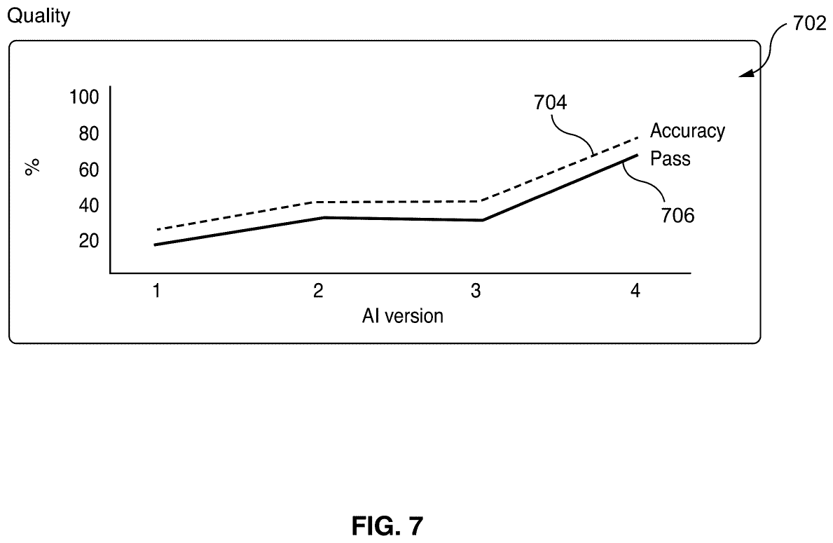

FIG. 7 illustrates the metrics associated with the accuracy rating for completion of the task shown in FIG. 4. In graphical representation 702, an accuracy rating 704 for four automated worker types is shown. Each of the four automated worker types is an artificial intelligence or “AI” worker of a different version or generation. The graphical representation 702 provides an easy-to-interpret reference to a user attempting to discern the quality advantages between different automated worker types. Also shown in graphical representation 702 is an accuracy rating benchmark 706. Benchmark 706 is a baseline accuracy rating against which the accuracy rating 704 of each automated worker is compared. Benchmark 706 may, for example, be a simple pass/fail metric wherein accuracy rating 704 for an automated worker that is below the benchmark 706 would “fail” and be rejected as a candidate for completion of the task and accuracy rating 704 that is above the benchmark 706 would “pass” and be considered acceptable candidate for completing the task. Difference between the accuracy rating and the accuracy rating benchmark may be used to rank each of the AI workers against the benchmark to determine expected gains or losses in quality between the AI worker types.

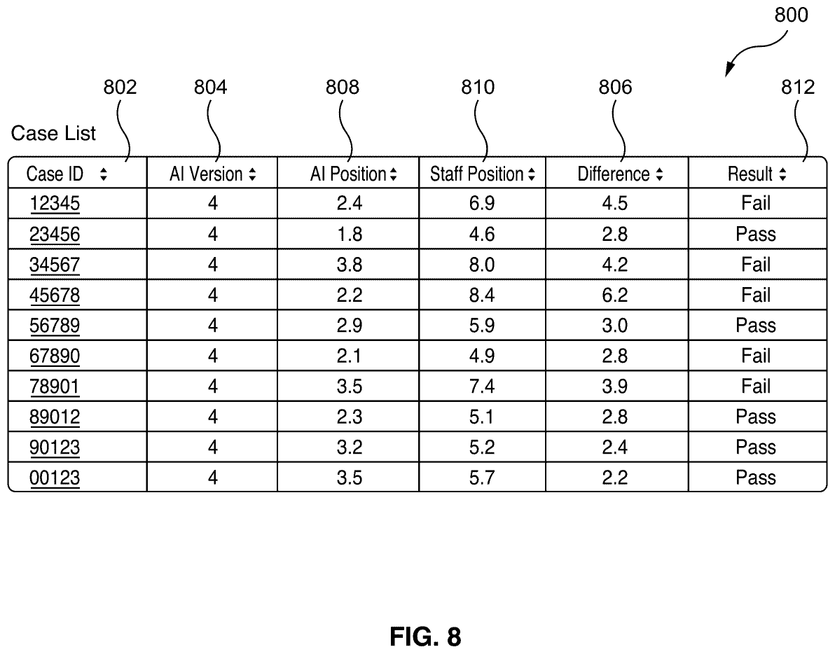

In FIG. 8, there is shown a table 800 representing the difference in accuracy rating between an automated AI worker and human worker for completing a variety of tasks. The task is identified by the task list 802 which identifies the particular task against which the performance indicators of each worker type are being compared. The task list 802 shown in FIG. 8 identifies tasks by number. However, it should be understood that each task may have its own distinct name by which it may be identified to system 100.

The automated worker is identified in the automated worker list 804 The identification may be by way of a version or generation number, wherein the listed number “4” denotes the fourth generation of the artificial intelligence worker. A difference 806 in accuracy metric between an automated worker and a human worker is shown in the table 800. The difference 806 for each task is determined by identifying the accuracy rating of the automated worker as first worker type, shown in automated worker position list 808 and the accuracy rating of human workers as the second worker type, shown in human worker position list 810 and taking the difference therebetween. Once the difference 806 is determined, a pass/fail score 812 is assigned to the automated worker for the performance of the corresponding task. An automated worker that is below the aforementioned benchmark 706 would “fail” and therefore not be selected as a candidate for automation of that task and an automated worker that is at or above the benchmark 706 would “pass” and would be acceptable as a candidate for automation of that task.

While the invention has been described in terms of specific aspects, it is apparent that other forms could be adopted by one skilled in the art. For example, the methods described herein could be performed in a manner which differs from the aspects described herein. The steps of each method could be performed using similar steps or steps producing the same result but which are not necessarily equivalent to the steps described herein. Some steps may also be performed in different order to obtain the same result. Similarly, the apparatuses and systems described herein could differ in appearance and construction from the aspects described herein, the functions of each component of the apparatus could be performed by components of different construction but capable of a similar though not necessarily equivalent function, and appropriate materials could be substituted for those noted. Accordingly, it should be understood that the invention is not limited to the specific aspects described herein. It should also be understood that the phraseology and terminology employed above are for the purpose of disclosing the illustrated aspects, and do not necessarily serve as limitations to the scope of the invention.

What is claimed is:

1. A computer-implemented method comprising:
acquiring, via an observability module, a plurality of performance indicators associated with a first worker type and a second worker type different from the first worker type for completing a task, wherein the plurality of performance indicators include task duration metrics, expense metrics and accuracy metrics;
inputting the acquired plurality of performance indicators to a computing module;
determining, via the computing module, a cost efficiency index, a task completion rate and an accuracy rating associated with each of the first worker type and the second worker type for completing the task;
determining, via the computing module, a difference between each of the cost efficiency index, the task completion rate and the accuracy rating of the first worker type and the second worker type for completing the task;
for each of the cost efficiency index, the task completion rate and the accuracy rating, ranking, via the computing module, each of the first worker type and the second worker type relative to one another based on the difference; and,
for each of the cost efficiency index, the task completion rate and the accuracy rating, forwarding a result of the ranking to a dashboard to display the result of the ranking via an output module in data exchange communication with the computing module.

2. The computer-implemented method of claim 1, wherein the plurality of performance indicators for at least one of the first worker type and the second worker type for completing the task is collected continually.

3. The computer-implemented method of claim 1, wherein display of the result of the ranking is concurrent with the ranking.

4. The computer-implemented method of claim 1, wherein relative ranking of the first worker type and the second worker type is displayed selectively based on difference between any one of the cost efficiency index, the task completion rate and the accuracy rating.

5. The computer-implemented method of claim 1, further comprising the step of generating, via an output module in data exchange communication with a graphical user interface, at least one graphical representation of the cost efficiency index, the task completion rate and the accuracy rating of the first worker type and the second worker type for completing the task and difference therebetween.

6. The computer-implemented method of claim 1, wherein each of the first worker type and the second worker type is selected from one of a human worker, an automated worker, a remote worker, and an outsourced worker.

7. The computer-implemented method of claim 1, wherein the performance indicators for each of the first worker type and the second worker type are collected over a plurality of repetitions of completion of the task and each of the cost efficiency index, the task completion rate and the accuracy rating associated with each of the first worker type and the second worker type for completing the task is calculated using performance indicators from the plurality of repetitions of completion of the task.

8. The computer-implemented method of claim 1, wherein the plurality of performance indicators further includes frequency-related data points, the frequency-related data points representing a frequency of performing the task.

9. The computer-implemented method of claim 1, wherein calculating the difference in task completion rate between the first worker type and the second worker type comprises:
determining a first task completion rate of the first worker type;
determining a second task completion rate of the second worker type; and,
calculating a difference between the first task completion rate and the second task completion rate.

10. The computer-implemented method of claim 1, wherein calculating the difference in the accuracy rating between the first worker type and the second worker type comprises:
recording a first accuracy rating for completing the task by the first worker type;
recording a second accuracy rating for completing the task by the second worker type; and,
calculating a difference between the first accuracy rating and the second accuracy rating.

11. The computer-implemented method of claim 1, further comprising the step of:
generating an infrastructure-as-code file, via an implementation engine, for implementing at least one change to a workflow associated with completion of the task based on the relative ranking of the first worker type and the second worker type.

12. The computer-implemented method of claim 11, wherein the infrastructure-as-code file includes at least one machine-readable definition file configured to define computer architecture required for implementing the at least one change.

13. A system comprising:
an observability module configured to acquire a plurality of performance indicators associated with a first worker type and a second worker type different from the first worker type for completing a task, wherein the plurality of performance indicators include task duration metrics, expense metrics and accuracy metrics;
a computing module configured to determine a cost efficiency index, a task completion rate and an accuracy rating associated with each of the first worker type and the second worker type for completing the task and to determine a difference between each of the cost efficiency index, the task completion rate and the accuracy rating of the first worker type and the second worker type for completing the task and for ranking each of the first worker type and the second worker type relative to one another based on the difference for each of the cost efficiency index, the task completion rate and the accuracy rating; and,
an output module in data exchange communication with the computing module configured to forward a result of the ranking to a dashboard to display the result of the ranking for each of the cost efficiency index, the task completion rate and the accuracy rating.

14. The system of claim 13, wherein the observability is configured to acquire the plurality of performance indicators for at least one of the first worker type and the second worker type for completing the task continually.

15. The system of claim 13, wherein the output module is configured to display the result of the ranking concurrently with the ranking.

16. The system of claim 13, wherein the output module is configured to display relative ranking of the first worker type and the second worker type selectively based on difference between any one of the cost efficiency index, the task completion rate and the accuracy rating.

17. The system of claim 13, further comprising:
a graphical user interface in data exchange communication with the output module configured to generate at least one graphical representation of the cost efficiency index, the task completion rate and the accuracy rating of the first worker type and the second worker type for completing the task and difference therebetween.

18. The system of claim 13, wherein each of the first worker type and the second worker type is selected from one of a human worker, an automated worker, a remote worker, and an outsourced worker.

19. The system of claim 13, further comprising:
an implementation engine configured to generate an infrastructure-as-code file for implementing at least one change to a workflow associated with completion of the task based on the relative ranking of the first worker type and the second worker type.

20. The system of claim 19, wherein the infrastructure-as-code file includes at least one machine-readable definition file configured to define computer architecture required for implementing the at least one change.
